(19) United States
(12) Patent Application Publication
(10) Pub. No.: US 2026/0360370 A1
(43) Pub. Date: Nov. 12, 2026

(54) METHOD AND DECODER FOR STEREO DECODING WITH A NEURAL NETWORK MODEL

(71) Applicant: DOLBY INTERNATIONAL AB, Dublin (IE)

(72) Inventor: Pedro Jafeth VILLASANA TINAJERO, Järfälla (SE)

(73) Assignee: DOLBY INTERNATIONAL AB, Dublin (IE)

(21) Appl. No.: 19/139,682

(22) PCT Filed: Dec. 15, 2023
(86) PCT No.: PCT/EP2023/086156

§ 371 Date: Jun. 16, 2025

Related U.S. Application Data
(60) Provisional application No. 63/433,737, filed on Dec. 19, 2022.

(30) Foreign Application Priority Data
Feb. 22, 2023 (EP) 23157900.4

(51) Int. Cl. G10L 19/008

(52) U.S. Cl. CPC G10L 19/008

(57) ABSTRACT

The present disclosure relates to a method and a decoder for reconstructing a stereo audio signal. The method comprises receiving (S1) a bitstream including an encoded first mono audio signal and a set of reconstruction parameters and decoding the encoded first mono audio signal to provide a first mono audio signal. The method further comprises either reconstructing (S3a) a second mono audio signal using a neural network system (24, 24a, 24b, 24c, 24d, 24e) trained to the second mono audio signal given samples of the first mono audio signal and said reconstruction parameters or reconstructing (S3a, S3b) a second mono audio and a third mono audio signal using a neural network system (24c, 24d, 24e) trained to predict the second and third mono audio signal given samples of the first mono audio signal and said reconstruction parameters.

### CROSS-REFERENCE TO RELATED APPLICATIONS

This application claims the benefit of priority from U.S. Provisional Application Ser. No. 63/433,737, filed on 19 Dec. 2022, and European Patent Application No. 23157900.4, filed on 22 Feb. 2023, each of which is incorporated by reference herein in its entirety.

### TECHNICAL FIELD

The present application relates to a method and decoder for stereo decoding, and particularly stereo reconstruction using a neural network model.

### BACKGROUND

Stereo audio is used to present many different types of audio content (e.g. music) and is suitable for rendering to earphones, stereo loudspeaker pairs or even surround sound loudspeaker arrangements with more than two loudspeakers using various upmixing techniques. Stereo audio consists of two audio signals, e.g. a left audio signal and a right audio signal, which together form a stereo pair. A left and right audio signal can be recorded using two microphones which are spatially displaced and/or using two directional microphones which are directed in different directions (e.g. at 90 degree angles). Despite only involving two audio signals, stereo audio can be used to produce immersive, three dimensional, spatial effects giving a listener a sense of direction in a rendered audio scene. For example, a user listening to stereo audio via earphones can perceive that the source of the audio content is somewhere between the ears of the listener (with the source moving with the panning of the audio signal) or that the source is outside of the user (with the source moving as the left and right audio signals are provided with a relative delay or processed with a head related transfer function (HRTF)).

It is also possible to represent stereo audio using audio signals pairs other than the left and right audio signal pair. For example, stereo audio may be represented with a mid audio signal and a side audio signal forming a mid-side stereo pair. There are different ways in which a mid-side audio pair can be captured or created. For example, a left and right stereo pair can be converted into a mid-side stereo pair or mid-side stereo pair can be recorded using an omnidirectional or forward directed microphone (recording the mid audio signal) and side-wards directed microphone recording the side audio signal. A benefit with a mid-side stereo pair is that the mid audio signal usually captures the most essential audio content making the mid-side stereo pair backwards compatible with mono playback systems which simply disregard the side audio signal and renders only the mid-audio signal.

For the same reason, mid-side stereo pair is often used when performing stereo encoding and stereo decoding. A stereo audio signal, comprising two audio signals, carries more information than a mono audio signal meaning that e.g. transmission of a stereo audio signal requires higher bitrate and that storage of a stereo audio signal requires a larger data volume. To this end, encoders have been proposed which obtain a left and right stereo pair, converts it into a mid and side stereo pair and encodes the mid audio signal as a downmix audio signal which is transmitted to the decoder along with some side parameters indicating the correlation between the left and right audio signal. Accordingly, only the downmix mid audio signal (the mid audio signal) is encoded and transmitted alongside the side parameters (constituting a comparatively small among of data) meaning that the encoded stereo representation is highly compressed. The decoder decodes the downmix mid audio signal and converts it to a left and right stereo pair guided by the side parameters.

While this type of encoding and decoding is not lossless it has proven efficient in retaining a high perceptual quality of the reconstructed stereo pair while offering a high level of compression. In some solutions, the downmix mid audio signal is passed through an all-pass filter with filter parameters selected to introduce a fixed temporal delay to generate a synthetic side signal from the downmix mid audio signal. An all-pass filter with fixed delays has proven to be a suitable method for producing a synthetic, yet convincing, side audio signal from a mid audio signal wherein the side audio signal has approximately the same temporal and spectral energy distribution as the downmix mid audio signal. The downmix mid audio signal and synthetic side audio signal are then used alongside the side parameters to convert this mid and side stereo pair into a left and right stereo pair.

### SUMMARY

A problem with the above mentioned previous solutions is that the decoding process fails to reproduce a convincing stereo pair when the original left and right audio signals are strongly decorrelated. Examples of strongly decorrelated audio includes audio signals representing rain sounds, the sound of applause or even some types of music. To this end, there is a need for an improved method of decoding encoded stereo audio which overcomes at least some of the shortcomings mentioned in the above.

According to a first aspect of the present invention there is provided a method for reconstructing a stereo audio signal. The method comprising the steps of receiving a bitstream including an encoded first mono audio signal and a set of reconstruction parameters and decoding the encoded first mono audio signal to provide a first mono audio signal. The method further comprises reconstructing a second mono audio signal using a neural network system trained to predict samples of the second mono audio signal given samples of the first mono audio signal and the reconstruction parameters, wherein the first mono audio signal and the reconstructed second mono audio signal forms a stereo audio signal pair.

With a stereo audio signal pair it is meant two audio signals which together form a stereo format. For example, the two audio signals of the stereo audio signal pair may have been recorded using two microphones in a stereo recoding configuration. It is also possible that the stereo audio signal pairs have been generated in a mixing process. The most common format of stereo audio signal pairs is left and right stereo audio signals, however many alternative formats of stereo audio signal pairs exist, such as mid and side stereo audio signals.

The bitstream is an encoded representation of an original stereo audio signal. By including a single mono audio signal and reconstruction parameters in the bitstream an efficient, and highly compressed, representation is achieved which facilitates stereo audio signal transmission or storage in a data storage medium. While the encoding process to achieve this representation in general is not lossless it has proven to allow accurate reconstruction of the original stereo audio signal pair with high perceptual quality.

The invention is at least partially based on the understanding that a trained neural network model will be able to reconstruct a second mono audio signal with higher quality compared to a second mono audio signal which has been calculated analytically in a conventional decoder. Especially, when there is low correlation between the audio signals of the original stereo audio signal pair the encoded representation simply does carry enough information to reconstruct the second mono audio signal accurately which leads to poor performance for conventional decoders. With the trained neural network model, on the other hand, a second mono audio signal can be reconstructed with perceptually much higher quality, even when there is low or no correlation between the original stereo audio signal. Thus, the efficient and highly compressed bitstream can still be used even when the correlation between the original stereo audio signals is low.

According to a second aspect of the invention there is provided a method for reconstructing a stereo audio signal comprising the steps of receiving a bitstream including an encoded first mono audio signal and a set of reconstruction parameters and decoding the encoded first mono audio signal to provide a first mono audio signal. The method further comprises reconstructing a second mono audio and a third mono audio signal using a neural network system trained to predict samples of the second mono audio signal and samples of the third mono audio signal given samples of the first mono audio signal and the reconstruction parameters, wherein the reconstructed second mono audio signal and the reconstructed third mono audio signals forms a stereo audio signal pair.

That is, as an alternative to the neural network model configured as a single output network, trained to reconstruct a second mono audio signal which forms a stereo audio signal pair with the first mono audio signal, the neural network model could be configured as a double output network, trained to reconstruct a second and third mono audio signal directly, wherein the second and third mono audio signal forms stereo audio signal pair. The second aspect of the invention features the same or equivalent benefits as the first aspect of the invention.

Additionally, the method of the second aspect of the invention enables the neural network model to introduce additional enhancements in the reconstruction of the stereo audio signal pair. For example, the second mono audio signal may still form a stereo audio signal pair with the first mono audio signal but the third mono audio signal is an enhanced version of the first mono audio signal which has been predicted by the neural network model and which offers enhanced perceptual quality.

As another example, the first mono audio signal may be of a stereo audio signal format (e.g. mid-side format) which is different from the desired output of a decoder (e.g. a left and right format). Thus, with this double output network the second and third mono audio signal may be of a desired stereo audio signal format (e.g. left and right format) different from the stereo audio format of the first mono audio signal.

In some implementations of the first and/or second aspect of the invention, the neural network system is trained to operate on flattened audio signal samples and the method further comprises envelope flattening the first mono audio signal, to produce a flattened first mono audio signal, and providing the flattened first mono audio signal to the neural network system. The method further comprises inverse-flattening at least the reconstructed second mono audio signal.

Thus, the neural network model is trained to operate on flattened samples of the first mono audio signal. By operating on flattened samples the performance of the neural network model may be enhanced while also allowing less complex neural network models to be used which are easier to train. In most audio content, the spectral energy content is higher for lower frequencies compared to higher frequencies, i.e. the audio content has a high dynamic range. If the samples of the audio signal are not flattened the neural network model will inherently prioritize accurate reconstruction of low frequencies over accurate reconstruction of high frequencies which could lead to noticeably distorted or lower quality reconstructed audio signals for some types of audio content. By flattening the samples, the spectral energy content will be more evenly disturbed across all frequencies meaning that the neural network model will put equal priority to accurate reconstruction of all frequencies which increases the quality of the reconstructed audio signals.

According to a third aspect of the invention there is provided a computer program product comprising instructions which, when the program is executed by a computer, causes the computer to carry out the method according to the first or second aspect of the invention.

According to a fourth aspect of the invention there is provided a computer-readable storage medium storing the computer program according to the third aspect of the invention.

According to a fifth aspect of the invention there is provided a decoder, comprising a processor and a memory coupled to the processor, wherein the processor is adapted to perform the method steps of the first or second aspect of the invention.

According to a sixth aspect of the invention there is provided a method for training a neural network for stereo reconstruction. The method comprising obtaining training data, the training data comprising a stereo audio signal pair and encoding the stereo audio signal pair into an encoded stereo audio signal, the encoded stereo audio signal comprising a first mono audio signal and reconstruction parameters. The method further comprises reconstructing a second mono audio signal using a neural network system trained to predict samples of the second mono audio signal given samples of the first mono audio signal and the reconstruction parameters and determining a difference measure between the reconstructed second mono audio signal and a ground truth second mono audio signal associated with the stereo audio signal pair of the training data. Finally, the method comprises modifying internal weights of the neural network model based on the determined difference.

The method for training a neural network according to the sixth aspect is suitable for training a neural network model according to the first aspect of the invention.

In some implementations, the neural network model is further configured to predict samples of a third mono audio signal given samples of the first mono audio signal and said reconstruction parameters, and the method further comprises reconstructing the third mono audio signal using the neural network model and determining the difference measure between the reconstructed third mono audio signal and a ground truth third mono audio signal associated with the stereo audio signal pair of the training data.

This implementation of the training method is suitable for training the neural network model used in the second aspect of the invention.

The third to sixth aspects of the invention features the same or equivalent benefits as the first and second aspects of the invention. Any functions described in relation to a method, may have corresponding features in a system and vice versa.

### BRIEF DESCRIPTION OF THE DRAWINGS

The present invention will be described in more detail with reference to the appended drawings, showing currently preferred embodiments of the invention.

FIG. 1a depicts a stereo encoder transmitting an encoded stereo bitstream to a stereo decoder according to some implementations.

FIG. 1b depicts a detailed view of a stereo encoder according to some implementations.

FIG. 2a depicts a detailed view of a stereo decoder according to some implementations.

FIG. 2b depicts a detailed view of another stereo decoder according to some implementations.

FIG. 2c depicts a detailed view of a stereo decoder with a double output neural network model according to some implementations.

FIG. 2d depicts a detailed view of another stereo decoder with a double output neural network model also performing stereo format conversion according to some implementations.

FIG. 3a depicts a single output neural network model according to some implementations.

FIG. 3b depicts a single output neural network model operating on flattened samples according to some implementations.

FIG. 3c depicts a double output neural network model operating on flattened samples according to some implementations.

FIG. 3d depicts a double output neural network model with stereo format conversion operating on flattened samples according to some implementations.

FIG. 3e depicts a double output neural network model with stereo format conversion into alternative formats according to some implementations.

FIG. 4a is flowchart describing a method of decoding a stereo audio signal with a single output neural network model according to some implementations.

FIG. 4b is flowchart describing a method of decoding a stereo audio signal with a double output neural network model according to some implementations.

FIG. 5a depicts a training setup for training a neural network model according to some implementations.

FIG. 5b is a flowchart describing a method for training a neural network model according to some implementations.

FIG. 6 illustrates a neural network model wherein a one of the neural network model and an LTI filter is used selectively, based on the content of the first mono audio signal according to some implementations.

### DETAILED DESCRIPTION

Systems and methods disclosed in the present application may be implemented as software, firmware, hardware or a combination thereof. In a hardware implementation, the division of tasks does not necessarily correspond to the division into physical units; to the contrary, one physical component may have multiple functionalities, and one task may be carried out by several physical components in cooperation.

The computer hardware may for example be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions (sequential or otherwise) that specify actions to be taken by that computer hardware. Further, the present disclosure shall relate to any collection of computer hardware that individually or jointly execute instructions to perform any one or more of the concepts discussed herein.

Certain or all components may be implemented by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system (i.e. a computer hardware) that includes one or more processors. Each processor may include one or more of a CPU, a graphics processing unit, and a programmable DSP unit. The processing system further may include a memory subsystem including a hard drive, SSD, RAM and/or ROM. A bus subsystem may be included for communicating between the components. The software may reside in the memory subsystem and/or within the processor during execution thereof by the computer system.

The one or more processors may operate as a standalone device or may be connected, e.g., networked to other processor(s). Such a network may be built on various different network protocols, and may be the Internet, a Wide Area Network (WAN), a Local Area Network (LAN), or any combination thereof.

The software may be distributed on computer readable media, which may comprise computer storage media (or non-transitory media) and communication media (or transitory media). As is well known to a person skilled in the art, the term computer storage media includes both volatile and non-volatile, removable and non-removable media implemented in any method or technology for storage of information such as computer readable instructions, data structures, program modules or other data. Computer storage media includes, but is not limited to, physical (non-transitory) storage media in various forms, such as EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by a computer. Further, it is well known to the skilled person that communication media (transitory) typically embodies computer readable instructions, data structures, program modules or other data in a modulated data signal such as a carrier wave or other transport mechanism and includes any information delivery media.

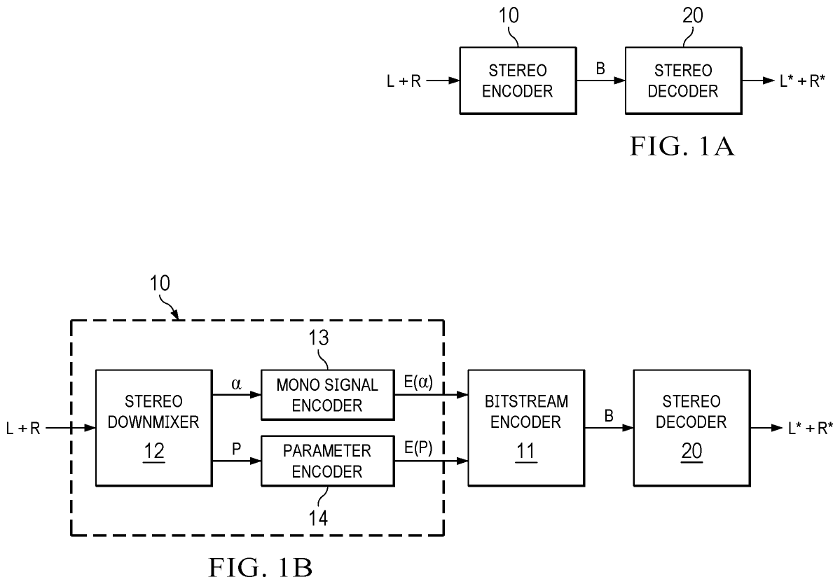

In FIG. 1a an encoder 10 and decoder 20 for encoding and decoding a stereo audio signal pair is presented. An original left audio signal L and original right audio signal R forming a stereo audio signal pair is provided to the encoder 10 which encodes the original stereo signal pair L, R to an encoded signal representation which is included in the bitstream B. Transforming the original stereo signal pair L, R to an encoded representation may be a lossy process wherein some information present in the original stereo audio signal pair has been omitted. For example, the encoder 10 omits one of the original left and right original audio signals L, R and includes the other one of the left and right original audio signal L, R in the bitstream B. The encoder 10 further extracts reconstruction parameters indicating a relationship (e.g. the covariance) between the original left and right original audio signal L, R wherein the reconstruction parameters are also included in the bitstream B. The bitstream B is then provided to the decoder 20 which reconstructs one of the left audio signal L* and/or reconstructed right audio signal R* from the contents of the bitstream B. In some embodiments, the decoder 20 reconstructs both a reconstructed left audio signal L* and a reconstructed right audio signal R*. Alternatively, the decoder 20 reconstructs the audio signal being the complement to the audio signal included in the bitstream B, i.e., only one of a reconstructed left audio signal L* and a reconstructed right audio signal R*.

In some embodiments, the encoder 10 transforms the original left and right original audio signal L, R into a mid-side stereo format and includes only the mid audio signal in the bitstream B alongside the reconstruction parameters indicating a property of the side audio signal. As the mid audio signal is expected to capture the most essential information of a stereo signal pair (e.g., most stereo audio signals are center panned meaning that most of the spectral energy will be comprised in the mid audio signal), including the mid audio signal in the bitstream B instead of one of the left and right audio signal L, R enables more accurate reconstruction in the decoder 20. The decoder 20 then reconstructs a reconstructed side signal or a reconstructed left audio signal L* and a reconstructed right audio signal R* using the content in the bitstream B.

With further reference to FIG. 1b the operation of the encoder 10 will now be described in further detail. An original left and right stereo signal pair L, R is received and provided to a stereo downmixing unit 12. The stereo downmixing unit 12 performs two tasks, it extracts a first mono audio signal α (e.g. in the form of a mid audio signal M), also referred to as a downmix audio signal, and it extracts reconstruction parameters P indicating a property of a relationship of the original left and right audio signal L, R. Extracting a mid audio signal M from a left and right audio signal L, R is for example achieved by the following equation:

M=GₗL+gᵣR (1)

wherein gₗ and gᵣ are channel weights, and setting gₗ and gᵣ equal to ½ yields a conventional mono audio signal. Similarly, a corresponding side audio signal, S, can be created as

S=gₗL−gᵣR. (2)

It is also envisaged that the encoder 10 extracts a target mid audio signal wherein weights gₗ and gᵣ change with time and/or frequency. For instance, the mid and side audio signals are determined as:

M=cos(Θ)L+sin(Θ)R (3)

S=sin(Θ)L−cos(Θ)R (4)

with gₗ=cos(Θ) and gᵣ=sin(Θ) and wherein Θ changes over time and optionally over frequency. The parameter Θ is referred to as a target panning parameter Θ and ranges from 0 to π/2 as it dictates the panning of a target audio source in the stereo pair L, R and the resulting dynamic mid and side audio signals are referred to as target mid and side audio signals.

This target mid and side audio signals relate to the left and right stereo pair via the time varying panning dictated by the target panning parameter Θ. To this end, it is possible that the target panning parameter Θ is transmitted with the reconstruction parameters P and used by the neural network model and/or mixer of the decoder when reconstructing the stereo audio signals in the left and right format. For example, the target panning parameter Θ varies over time and frequency to extract a target mid audio signal which captures a dominating audio source in each frequency band. To this end, the target panning parameter Θ could be set to an estimated panning in each frequency band. For example, the target panning parameter Θ is calculated as arctan(|R|/|L|) where |R| and |L| is the spectral energy of the left and right audio signal L, R for a particular time segment and frequency band. For instance, if the left signal contains most spectral energy for a certain frequency band and time segment, Θ=arctan(|R|/|L|) approaches 0 meaning that the target mid audio signal will be dominated by the left channel.

Additionally, it is envisaged that a target phase difference parameter Φ may be obtained for each time segment and frequency band of the left and right stereo pair. For instance, the target phase difference parameter Φ is determined as Φ=Arg(R/L) for each time segment and frequency band. The target phase difference parameter Φ may then be used together with the target panning parameter Θ to extract the target mid and side audio signals based on both the target panning parameter Θ and the target phase difference parameter Φ as

M=cos(Θ)e^{i(-Φsin}^{²}^{Θ)}L+sin(Θ)e^{i(+cos}^{²}^{Θ)}R (5)

S=sin(Θ)e^{i(-Φsin}^{²}^{Θ)}L−cos(Θ)e^{i(+cos}^{²}^{Θ)}R (6)

whereby the target panning parameter Θ and the target phase difference parameter Φ are transmitted with the reconstruction parameters P and used by the neural network model and/or mixer of the decoder when reconstructing the stereo audio signals in the left and right format.

Thus, while a conventional mid audio signal captures centered panned audio sources with no phase difference, the target mid audio signal obtained with equation 3 or equation 5 above will dynamically target a source which varies over time in frequency, panning and phase in the left and right stereo audio signal to enable the most prominent audio source to always be present in the target mid audio signal. In other words, with the target mid audio signal the risk of not including the dominating audio source in stereo mix is reduced, even if the dominating source is varying in panning, phase or frequency over time.

The extraction and utilization of the target panning parameter Θ and/or the target phase difference parameter Φ, as well as the reconstruction of left and right stereo audio signals from target mid and side audio signals is described in more detail in “TARGET MID-SIDE SIGNALS FOR AUDIO APPLICATIONS” filed as U.S. Provisional Application No. 63/318,226 on Mar. 9, 2022, hereby incorporated by reference in its entirety.

Extracting reconstruction parameters P may involve extracting at least one of the Inter-channel Intensity Difference (IID), the Inter-channel Cross-Correlation (ICC), the Inter-channel Phase Difference (IPD) and the Inter-channel Time Difference (ITD) of the original left and right audio signals.

Inter-channel Intensity Difference or IID indicates the intensity difference between the two signals in the original stereo signal pair L, R.

Inter-channel Cross-Correlation or ICC indicates the cross-correlation or the coherence of the two signals in the original stereo signal pair L, R. In some embodiments, the coherence is determined as the maximum of the cross-correlation as a function of time or phase.

Inter-channel Phase Difference or IPD indicates the phase difference between the two signals in the original stereo signal pair L, R. An alternative to the IPD is the Inter-channel Time Difference or ITD which indicates the time difference between the two signals of the original stereo audio signals L, R.

It is also envisaged that the reconstruction parameters indicate the target panning parameter Θ and/or the target phase difference parameter Φ for each time segment and frequency band. This allows the neural network model and/or mixer of the decoder to reconstruct the original left and right audio signal from a target mid audio signal extracted using the target panning parameter Θ and/or the target phase difference parameter Φ.

In some embodiments, the first mono audio signal α is provided to a mono signal encoder 13 configured to encode the first mono audio signal α into an encoded first mono audio signal E(α). The encoding performed by the mono signal encoder may be lossless or lossy. Lossy encoding enables the first mono audio α to be compressed. For instance, the mono signal encoder 13 may perform downsampling or quantization of the first mono audio signal α. Although the bitstream encoder 11 is depicted as being separate from the encoder 10 it is also possible that the bitstream encoder 11 is a part of the encoder 10 which then accepts a pair of stereo audio signals L, R as an input and outputs an encoded bitstream B.

In some embodiments, the reconstruction parameters P are also compressed using e.g., quantization, performed by the quantizer 14.

The (optionally encoded) first mono audio signal and the (optionally encoded) reconstruction parameters P are provided to a bitstream encoder 11 which encodes the information into a bitstream B. The bitstream B is then stored or transmitted (e.g. over a network) to a decoder 20.

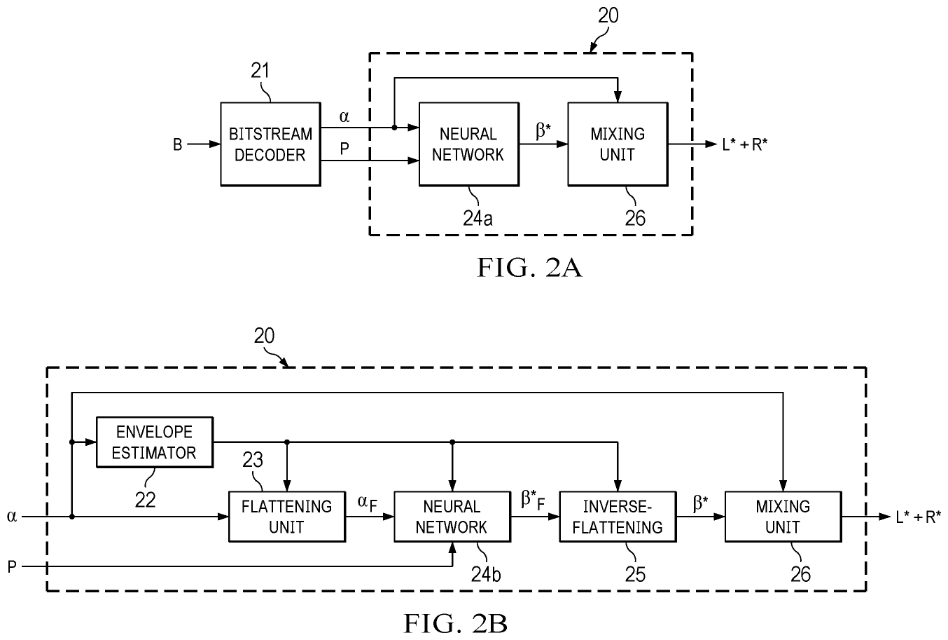

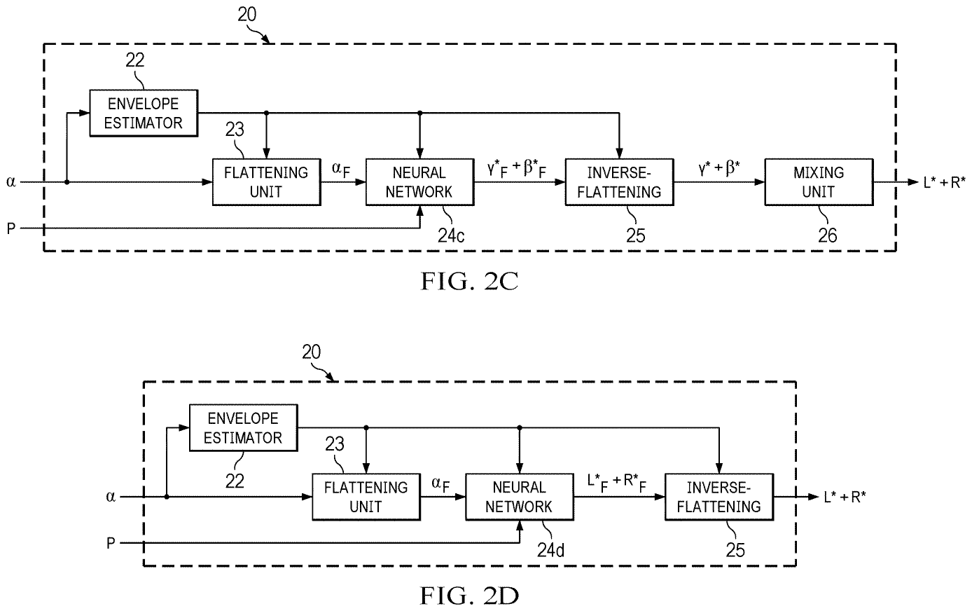

As seen in FIG. 2a the bitstream B is received by a bitstream decoder 21 which decodes the bitstream B to obtain the first mono audio signal α and the reconstruction parameters P contained in the bitstream B. The bitstream decoder 21 may be provided separately from the stere decoder 20 or integrated therewith. The bitstream decoder 21 decodes the bitstream encoding and any encoding encapsulating the first mono audio signal α and the reconstruction parameters P, and provides the first mono audio signal α and the reconstruction parameters P to the neural network model 24a of the stereo decoder 20.

In some implementations, samples of the first mono audio signal α and reconstruction parameters P are provided as input parameters to the neural network model 24a trained to predict samples of a reconstructed second mono audio signal α*. The first mono audio signal α and the reconstructed second mono audio signal β* forms a stereo audio signal pair. For instance, the first mono audio signal α is a mid audio signal and the reconstructed second mono audio signal β* is a side audio signal wherein these two audio signals forms a mid and side stereo audio signal pair.

Optionally, the first mono audio signal α and the reconstructed second mono audio signal β* are provided to a mixing unit 26 which mixes the first mono audio signal α and the reconstructed second mono audio signal β to form a reconstructed left and right stereo audio signal pair L*, R* if the first mono audio signal α and the reconstructed second mono audio signal β* are not already in the left and right stereo audio signal format. For example, the mixing unit 26 is provided with the target panning parameter Θₓ and uses this parameter to reconstruct the left and right audio signals L*, R*.

The neural network model 24a may comprise any type of neural network. For example, the neural network is a Recurrent neural network (RNN) or a convolutional neural network (CNN). In some implementations, the neural network may comprise a plurality of neural network layers.

The neural network model 24a may comprise a generative model. A generative model is a neural network that implements probability distribution (e.g., a conditional probability distribution), which models the probability distribution of the dataset on which the neural network has been trained. The reconstruction of the second, and optionally third, mono audio signal β* is achieved by random sampling according to the probability distribution implemented by the trained neural network.

The architecture of the generative model may e.g., resemble that of the generative model described in detail in “HIGH FREQUENCY RECONSTRUCTION USING NEURAL NETWORK SYSTEM” filed as U.S. Provisional Application No. 63/331,056 on Apr. 14, 2022, hereby incorporated by reference in its entirety. This generative model reconstructs a filter bank domain high-band signal using a neural network system trained to predict samples of a high-band audio signal in the filter bank domain given samples of the filter bank domain low-band signal and high frequency reconstruction (HFR) parameters, wherein the HFR parameters describe properties of the higher frequency bands. In one example, the neural network system comprises an upper neural network tier and a neural network bottom tier. In the upper neural network tier, previously generated filter-bank samples are received together with the decoded low-band samples and the high frequency reconstruction parameters. The bottom neural network tier is divided into a plurality of sequentially executed sub-layers, each sub-layer is configured to generate a set of channels of the reconstructed high frequency band. In some implementations, the generative model also reconstructs an enhanced low-band audio signal.

The difference when applying this generative model used for high-frequency reconstruction for audio signal reconstruction being in the size of the output, which depends on whether the neural network model generates a single mono audio signal as output or two mono audio signals as output. It is envisaged that the same architecture could be trained for stereo audio signal reconstruction by providing, to the first tier, the first mono audio signal instead of the low-band signal and the reconstruction parameters P instead of the HFR parameters. Wherein the output is the second mono audio signal (instead of the high-band audio signal) or the output is the second mono audio signal (instead of the high-band audio signal) and the third mono audio signal (instead of the enhanced low-band audio signal).

In FIG. 2b a decoder 20 according to some implementations is depicted. The decoder 20 comprises some components which are identical with the corresponding component of the decoder of FIG. 2a (e.g., the mixing unit 26). The decoder 20 of FIG. 2b further comprises an envelope estimator 22 and a flattening unit 23. Additionally, the decoder 20 may comprise or be associated with a bitstream decoder as described in connection to the embodiment of FIG. 2a.

The envelope estimator 22 is configured to obtain the first mono audio signal α and estimate the spectral envelope of this audio signal. In some embodiments, the spectral envelope is estimated for a number of frequency bands. For instance, the spectral envelope is a parametric representation of the spectral energy of each QMF-band in the first mono audio signal α. The spectral envelope may be represented with one, two, or at least three parameter values per frequency band. In some implementations, the audio signals are represented with a predetermined number (e.g. 32) of QMF bands which vary over time in segments wherein each band is associated with one reconstruction parameter (e.g. an IID-, ICC-, or IPD-value) that is updated for each time segment.

The spectral envelope is provided to a flattening unit 23. The flattening unit 23 is configured to flatten the first mono audio signal α so as to provide flattened samples α_{F} of the first mono audio signal α to the neural network model 24b. Accordingly, the neural network model 24b is trained to predict flattened samples of the second mono audio signal β*_{F} provided flattened samples α_{F} of the first mono audio signal α. Thus, while the neural network model 24a of FIG. 2a is trained to operate on original (non-flattened) samples of the first mono audio signal α, the neural network model 24b is trained to operate on flattened samples α_{F}. The neural network model 24b also receives the reconstruction parameters P as an input.

Optionally, the neural network model 24b also receives the spectral envelope as input, wherein the neural network model 24b is trained to predict the reconstructed second mono audio signal β* based on three types of input data: the flattened samples of the first mono audio signal α, the reconstruction parameters P, and the spectral envelope.

By allowing the neural network model 24b to operate in the flattened domain, the neural network model 24b can be made less complex (e.g. fewer layers and/or fewer parameters) and/or the training of the neural network model 24b is more efficient. Additionally, experiments have shown that providing the spectral envelope as condition for the neural network model 24b is beneficial for prediction accuracy.

The reconstructed flattened samples β*_{F} are provided to an inverse-flattening unit 25 which performs the inverse operation of the flattening unit 23 to obtain non-flattened samples β*_{F}. To this end, the spectral envelope is provided to the inverse-flattening unit 25 alongside the reconstructed flattened samples β*_{F}. The inverse flattening unit 25 accepts as an input the flattened reconstructed second mono audio signal β*_{F} (e.g. a flattened reconstructed side audio signal), and outputs inverse-flattened audio signal samples β* (i.e. the reconstructed audio signal with no flattening).

The inverse flattened reconstructed second mono audio signal β* output by the inverse-flattening unit 25 is provided to the mixing unit 26 which mixes the inverse flattened reconstructed second mono audio signal β* with the first mono audio signal α to obtain a reconstructed left and right stereo audio signal pair L*, R*.

In FIG. 2c a decoder 20 is schematically illustrated with a neural network model 24c trained to predict a (flattened) second reconstructed mono audio signal β*_{(F)} and a (flattened) third reconstructed mono audio signal γ*_{(F)} given the (flattened) first mono audio signal α_{(F)} and reconstruction parameters P.

In some embodiments, the reconstructed third mono audio signal γ* is an enhanced version of the first mono audio signal α. For instance, the first mono audio signal α is a mid audio signal, the reconstructed second mono audio signal β* is a side audio signal and the reconstructed third mono audio signal γ* is an enhanced mid audio signal.

As described in the above, the first mono audio signal α may be compressed, quantized or processed with any form of lossy audio encoding technique. To this end, the neural network model 24c can be trained to produce an enhanced version of the first mono audio signal α in addition to the reconstructed second mono audio signal.

Optionally, the mixing unit 26 mixes the reconstructed third mono audio signal with the reconstructed second audio signal to produce a reconstructed left and right stereo audio signal L*, R* with enhanced quality.

FIG. 2d shows yet another embodiment of the decoder 20 wherein the neural network model 24d has been trained to output samples of a (flattened) left and right stereo audio signal pair L*_{F}, R*_{F} directly provided samples of the first mono audio signal α and the reconstruction parameters P. This allows e.g. the mixing unit 26 to be omitted completely from the decoder 10.

The first mono audio signal α may be any one of a mid audio signal, a side audio signal, a left audio signal and a right audio signal. In fact, many variations are possible, and in general terms the neural network model 24a, 24b, 24c, 24d receives a first mono audio signal α being a first part of a first stereo format and reconstruction parameters P describing a property of the second part of the first stereo format. The neural network model 24a, 24b, 24c, 24d is trained to output either (a) a reconstructed first format audio signal being the second part of the first stereo format or (b) two reconstructed second format audio signals being a first and second part of a second stereo format wherein the second stereo format is different from the first stereo format. For instance, the neural network model 24a, 24b, 24c, 24d obtains a left audio signal and reconstruction parameters associated with the right audio signal and outputs the right audio signal or the neural network model 24a, 24b, 24c, 24d obtains a mid audio signal and reconstruction parameters associated with the side audio signal and outputs a left and right stereo audio signal pair. As a further example, the first mono audio signal α is a mid audio signal and the parameters P describe a property of the corresponding side audio signal, wherein the neural network model 24 d directly predicts a reconstructed (flattened) left and right stereo audio signal pair L*_{F}, R*_{F}.

While the decoder 20 of FIG. 2d operates on flattened samples it is understood that the envelope estimator 22, flattening unit 23 and inverse-flattening unit 25 may be omitted to allow the neural network module 24d to operate on un-flattened samples.

In the embodiments depicted in FIG. 1a-1b and FIG. 2a-2d above, it is illustrated that the encoder 10 receives an original left and right audio signal L, R. In some embodiments (not shown), the encoder 10 instead receives original audio signals of a mid-side format or any other type of stereo audio signal format. Irrespective of the type of stereo format is received by the encoder 10, the encoder 10 encodes a bitstream B carrying a representation of a mono audio signal and reconstruction parameters describing at least one property of the relationship between the original audio signals. For example, the encoder 10 receives a left and right audio signal L, R and includes in the bitstream B one of the left and right audio signals L, R and reconstruction parameters P describing a property of the other one of the left and right audio signals L, R.

The encoder 10 and decoder 20 described in the above may operate on audio signals in the time domain and/or in the frequency domain (e.g. in the QMF-domain). For example, the encoder 10 converts the first mono audio signal and reconstruction parameters into a time-frequency domain format (such as QMF). Accordingly, the neural network model 24a, 24b, 24c, 24d may be trained to predict the second (and optionally the third) mono audio signal based on time domain samples of the first mono audio and reconstruction parameters describing time domain properties. Alternatively, the neural network model 24a, 24b, 24c, 24d may be trained to predict the second (and optionally the third) mono audio signal based on frequency domain samples of the first mono audio and reconstruction parameters describing frequency domain properties.

In legacy decoders without a neural network model 24a, 24b, 24c, 24d it is common for the other components in the decoder (e.g. the upmixing unit) to operate in a filter-bank domain with a predetermined number of frequency bands. The neural network model 24a, 24b, 24c, 24d may then preferably be trained to operate in the same filter-bank domain to facilitate easy implementation in legacy decoders.

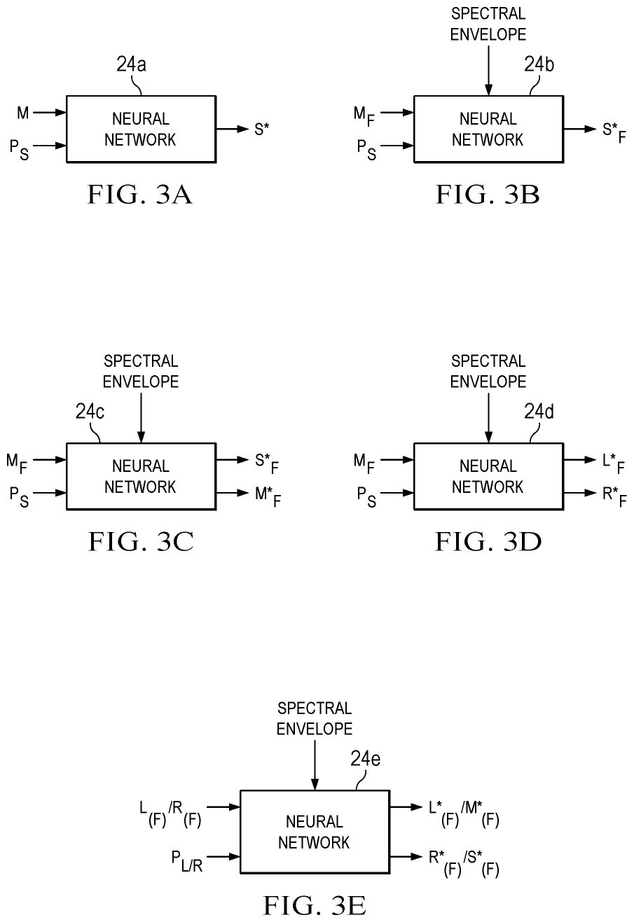

FIGS. 3a, 3b, 3c, 3d and 3e depicts some implementations of the different neural network models described in the above and specific examples of the first, second and third mono audio signals.

The neural network model 24a of FIG. 3a is trained to obtain samples of a mid audio signal M as well as reconstruction parameters P_{S} indicating a property of the associated side audio signal S and output a reconstructed side audio signal S*. That is, the neural network model 24a is a single output network and the first and second mono audio signal forms a stereo audio signal pair of a mid-side format.

The neural network model 24b of FIG. 3b is equal to that of the neural network model 24a from FIG. 3a besides the fact that the neural network model 24b of FIG. 3b is trained to operate on flattened samples, and optionally reconstruction parameters Ps associated with a flattened audio signal. In some implementations, the spectral envelope (determined in connection to flattening the samples) is also provided to the neural network model 24b as additional input data. Experiments have shown that when the samples of the first mono audio signal (e.g. the mid audio signal M) are flattened, providing the envelope to the neural network model 24b facilitates performance of the neural network model 24b.

The neural network model 24c of FIG. 3c also operates on flattened audio signal samples, however it is envisaged that the same neural network model 24c may also be trained to operate on non-flattened samples. The neural network model 24c is a double output network trained to obtain a flattened mid audio signal M_{F} (the first mono audio signal) and reconstruction parameters P_{S} associated with the corresponding side audio signal and outputs two flattened audio signals: the reconstructed side audio signal S*_{F} (second mono audio signal) and an enhanced reconstructed mid audio signal M*_{F} (third mono audio signal). These audio signals S*_{F}, M*_{F} forms their own stereo audio signal pair and may be outputted (after inverse-flattening) as a stereo audio signal or mixed to form a different stereo audio signal pair (e.g. a left and right stereo audio signal pair). Also, as in the embodiment described in FIG. 3b, the neural network model 24c is provided with the spectral envelope as additional input data in some implementations.

The neural network model 24d of FIG. 3d also operates on flattened audio signal samples, however it is envisaged that the same neural network model 24d may be trained to operate on non-flattened samples. Similar to the neural network model 24c, the neural network model 24d of FIG. 3d outputs two audio signals, however, the outputted reconstructed audio signals L*_{F}, R*_{F} of the neural network model 24d are of a different stereo format than that of the first mono audio signal M_{F}. As seen in FIG. 3d, the first mono audio signal is a mid audio signal of a mid-side stereo format whereas the outputted reconstructed stereo audio signals are of a left and right stereo format.

Also, as in the embodiment described in FIG. 3b and FIG. 3c, the neural network model 24d is provided with the spectral envelope as additional input data in some implementations.

Although FIG. 3a-3d depicts many of the possible implementations these examples are not exhaustive. As seen in FIG. 3e, it is also envisaged that the first mono audio signal provided to a neural network model 24e is a left or right audio signal L, R with the reconstruction parameters P_{L/R} indicating a property of the other one of the left or right audio signal L, R. The output of the neural network model 24e may be a single signal or double signals. The single signal being the reconstruction of the one of the left or right audio signal which does not constitute the first mono audio signal. The double output audio signals may be a reconstructed/enhanced left and right audio signal L, R (i.e. the stereo format is maintained by the neural network model) or a reconstructed stereo audio signal pair of a different stereo format such as a mid-side format M, S. Additionally, in some implementations, the neural network model 24e is provided with the spectral envelope of the flattened samples representing the left or right audio signal L, R which may facilitate performance.

Thus, a neural network 24e and stereo decoder is envisaged which operates in an analogous manner to the neural networks and stereo decoder embodiments described in the above with the input first mono audio signal being anyone of a side audio signal S, a left audio signal L, and a right audio signal R.

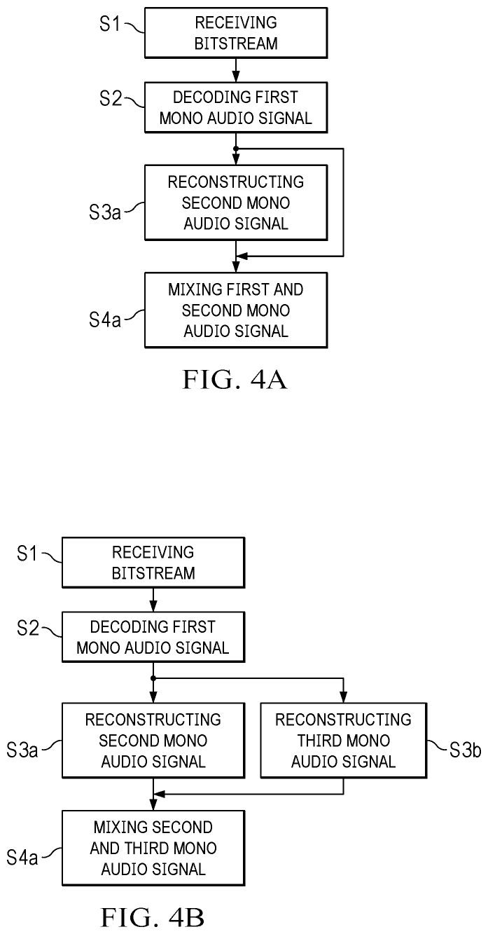

With reference to the flowchart in FIG. 4a and FIG. 2a a method for decoding a stereo audio signal will now be described in detail. At step S1 a bitstream B is received by the decoder 20, the bitstream comprising an encoded first mono audio signal α and reconstruction parameters P. At step S2 the decoder 20 decodes the encoded first mono audio signal α and the encoded reconstruction parameters P provides the decoded first mono audio signal α to the neural network model 24a alongside the reconstruction parameters P. At step S3a a second mono audio signal β* is reconstructed by the neural network model 24a and the first and second mono audio signal forms a stereo audio signal pair. For example, the first and second mono audio signal, α, β is a mid and side stereo audio signal or a left and right stereo audio signal. Optionally, the first and second mono audio signal are provided to, and mixed, by a mixing unit 26 at step S4a so as to convert the first and second mono audio signal into a different alternative stereo format.

Embodiments are also envisaged in which two audio signals are reconstructed as will now be described with reference to FIG. 2c and FIG. 4b wherein the method also comprises receiving a bitstream at step S1 and decoding the first mono audio signal α at step S2 as described in the above. However step S3b is also carried out in which the neural network model 24b reconstructs the third mono audio signal γ* in addition to the second mono audio signal β* reconstructed at step S3a. Steps S3a and S3b may occur in sequence or simultaneously. The second and third reconstructed mono audio signals β*, γ* forms a stereo audio signal pair of the same format as the format to which the first mono audio signal belongs or a different stereo format which may be outputted by the decoder 20. However, it may be desired to output stereo audio of format different from that of the second and third mono audio signals β*, γ* meaning that these signals are optionally mixed in the mixing unit 26 at step S4b so as to create a stereo audio signals of a desired format.

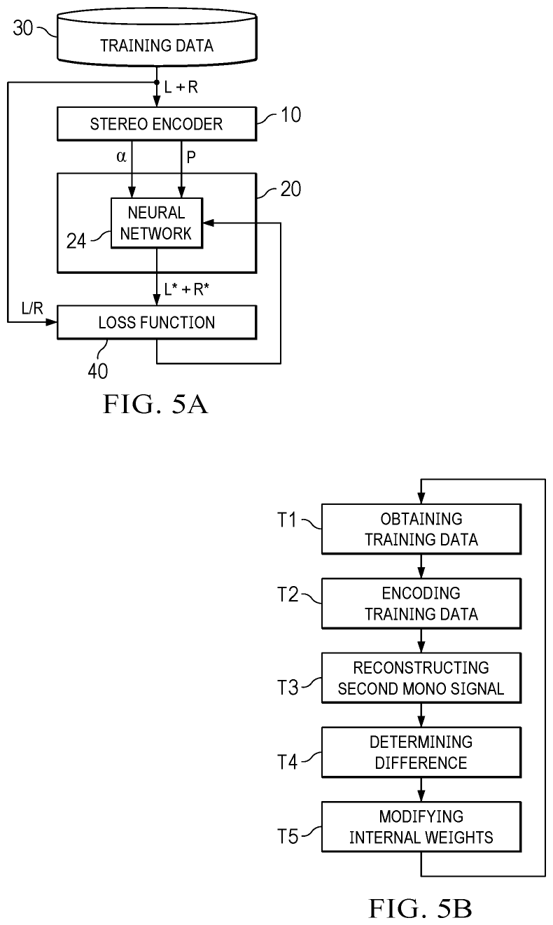

In FIG. 5a a setup for training any of the neural network models described in the above is depicted and in FIG. 5b a method for training any such neural network is illustrated. At step T1 training data is obtained, for example from a database 30 comprising training data. The training data comprises at least one example of a stereo audio signal pair (e.g. a left right stereo audio signal pair L, R) and is provided to a stereo encoder 10. At step T2 the stereo encoder 10 encodes the stereo audio signal pair into a bitstream containing a first mono audio signal (such as a mid audio signal M) and reconstruction parameters P indicating at least one property of a stereo audio signal associated with the first mono audio signal.

The encoding process implemented by the encoder 10 may be a lossy process, meaning that the information contained in the bitstream may not comprise sufficient information to perfectly reconstruct the stereo audio signal pair L, R input to the encoder 10.

At step T3 the first mono audio signal and the reconstruction parameters are provided to the decoder 20 which outputs a reconstructed stereo audio signal pair L*, R*. The decoder 20 may be any one of the decoders described in connection to FIGS. 2a, 2b, 2c, 2d in the above and comprises a neural network model 24 which is the subject of the training.

At step T4 the reconstructed stereo audio signal pair L*, R* is provided to a loss function unit 40 which compares the original stereo audio signal pair L, R to the reconstructed and reconstructed stereo audio signal pair L*, R* and determines a difference measure (also called a loss) between the original and the reconstructed stereo audio signal pairs.

It is envisaged that many different loss functions could be used to determine the difference measure, one suitable example of a loss function is the Negative Log Likelihood (NLL) loss. It is also envisaged that a discriminator, a so called learnable loss function, could be used wherein the decoder 20 (comprising the neural network model 24) acts a generator and the loss function unit 40 comprises an additional neural network acting as a discriminator. The discriminator and generator are then trained used traditional generator/discriminator training.

Based on the difference measure determined by the loss function unit 40 the internal weights and parameters of the neural network model 24 is updated at step T5 so as to reduce the difference measure.

The above process is then repeated with new training data (or at least augmented training data) used in each iteration until the weights and parameters of the neural network model 24 have been calibrated to result in sufficiently small difference measures over a wide variety of training data.

In FIG. 5a it is assumed that the audio signals of the training data and the audio signals output by the decoder 20 are in the same left-right L, R stereo format. In some implementations however, the training data is in a different stereo format (e.g. mid-side format) and/or there is a mismatch between the stereo format outputted by the decoder 20 compared to the format training data in the database 30. In such implementations, the loss function unit 40 is configured to convert the stereo format output by the decoder 20 and/or the stereo format of the ground truth training data 30 to enable calculation of the loss.

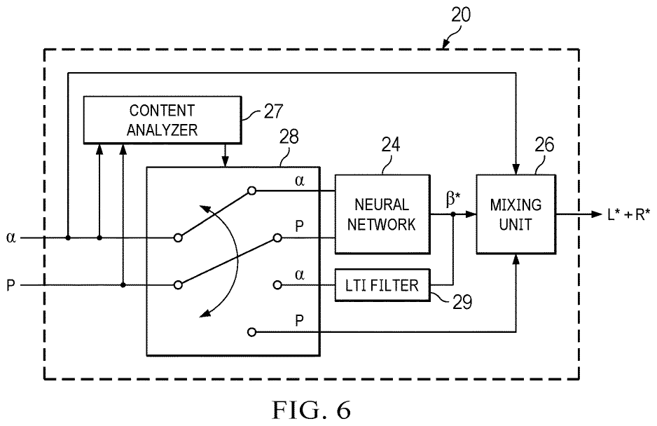

FIG. 6 shows yet another embodiment of a decoder 20 implementing a neural network module 24. The neural network module 24 could be anyone of the neural network modules 24a, 24b, 24c, 24d, 24e described in the above and may be variants thereof operating with flattened or non-flattened audio signal samples.

The decoder 20 in FIG. 6 comprises a content analyzer 27 configured to determine a correlation level for the audio content of the bitstream (embodied by the first mono audio signal and the reconstruction parameters). The correlation level indicates a level of correlation between the first mono audio signal α and a stereo audio signal associated with the first mono audio signal α. For example, if the bitstream carrying the first mono audio signal α and the reconstruction parameters P is obtained by encoding a left and right audio signal pair the correlation level will indicate the level of correlation between the left and right audio signal.

In some embodiments, the correlation level is determined by the content analyzer based on the reconstruction parameters P. For instance, the reconstruction parameters may comprise a parameter P which indicates the level of correlation directly. In some embodiments, the content analyzer 27 comprises a neural network trained to predict the correlation level based on samples of the first mono audio signal α and optionally also the reconstruction parameters P. For instance, the content analyzer 27 may be trained to determine the type of audio content (e.g. speech, music, the sound of applause or the sound of rain) present in the first mono audio signal α wherein some content types (e.g. the sound of applause or rain) is associated with a low level of correlation.

The correlation level is provided to a selection module 28 which selects whether to provide the first mono audio signal M and the reconstruction parameters to the neural network module or to a predetermined Linear Time Invariant (LTI) filter 29. The LTI filter 29 may be realized with a delay line which imposes a (optionally frequency varying) delay to the audio signals in the time domain. Alternatively or additionally, the LTI filter 29 comprises infinite impulse response (IIR) and/or finite impulse response (FIR) filters simulating reverberation.

The delay in the time domain may be varying with frequency, e.g. with higher frequency bands being subjected to smaller delays. If the correlation level is below a predetermined threshold, the selection module selects 28 the neural network module 24 and if the correlation level is above the predetermined threshold the selection module 28 selects the LTI filter 29. As described in the above the neural network model 24 is especially well suited for reconstructing a second (and optionally third) mono audio signal when there is low correlation between the channels of the stereo audio signal pair which is described by the first mono audio signal α and the reconstruction parameters P. Thus, with the decoder 20 of FIG. 6 the neural network model 24 is used when is most needed and the simpler LTI filter 29 is used for reconstruction of correlated stereo audio signal pairs.

With an LTI filter 29 it is meant a filter comprising a set of filter coefficients determined analytically to perform a specific task, in this case the task of imposing a time domain delay and/or reverberation to the audio signal. Additionally, or alternatively, the delay filter comprises a delay unit configured to introduce a predetermined (possibly frequency varying) delay. Depending on the desired time delay, (e.g. 10 milliseconds or 2 milliseconds) the filter coefficients of the LTI filter 29 can be calculated analytically. For example, if an LTI filter 29 introduces a delay which decreases linearly with frequency, the LTI filter would have the impulse response of a chirp signal. An example of an LTI filter 29 is e.g. presented in Engdegård et at. “Synthetic Ambience in Parametric Stereo Coding”, 2004. When the LTI filter is used the reconstruction parameters P are provided to the mixing unit 26 which performs mixing to change the stereo format in accordance with the reconstruction parameters P. This type of mixing which takes the reconstruction parameters P into consideration is also described in detail in the above mentioned reference.

In some implementations, the neural network model 24 comprises at least one of: a plurality of (learnable) neural network layers, non-linear activation layers (with e.g.

Rectified Linear Units, ReLU), at least one Long Short-Term Memory (LSTM) layer, at least one recurrent layer (such as a layer comprising Gated Recurrent Units, GRUs) meaning that the neural network model 24 is clearly distinguished from the LTI filter 29 which is both linear and time-invariant.

Unless specifically stated otherwise, as apparent from the following discussions, it is appreciated that throughout the disclosure discussions utilizing terms such as “processing”, “computing”, “calculating”, “determining”, “analyzing” or the like, refer to the action and/or processes of a computer hardware or computing system, or similar electronic computing devices, that manipulate and/or transform data represented as physical, such as electronic, quantities into other data similarly represented as physical quantities.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention. Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with instructions for carrying out such a method or element of a method forms a means for carrying out the method or element of a method. Note that when the method includes several elements, e.g., several steps, no ordering of such elements is implied, unless specifically stated. Furthermore, an element described herein of an apparatus embodiment is an example of a means for carrying out the function performed by the element for the purpose of carrying out the embodiments of the invention. In the description provided herein, numerous specific details are set forth. However, it is understood that embodiments of the invention may be practiced without these specific details. In other instances, well-known methods, structures and techniques have not been shown in detail in order not to obscure an understanding of this description.

Thus, while there has been described specific embodiments of the invention, those skilled in the art will recognize that other and further modifications may be made thereto without departing from the spirit of the invention, and it is intended to claim all such changes and modifications as falling within the scope of the invention. For example, while most depicted embodiments involve a decoder configured to obtain a mid stereo audio signal and reconstruction parameters indicating a property of the corresponding side audio signal to reconstruct a left and right audio signal it is understood that many alternative decoders fall within the scope of this disclose. Such as a decoder configured obtain a side audio signal (and reconstruction parameters associated with a mid audio signal) to reconstruct left and right audio signals, a decoder configured obtain a left audio signal (and reconstruction parameters associated with a right audio signal) to reconstruct left and right audio signals and a decoder configured obtain a right audio signal (and reconstruction parameters associated with a left audio signal) to reconstruct left and right audio signals. Each of these exemplary decoders may also be configured to output stereo audio signal pairs of different formats than the left and right format, such as a mid-side or target mid-side format. Additionally, decoders with and without spectral flattening and the associated components (envelope estimator, flattening unit, inverse-flattening unit) are also envisaged.

1. A method for reconstructing a stereo audio signal, comprising:
receiving a bitstream including an encoded first mono audio signal and a set of reconstruction parameters;
decoding the encoded first mono audio signal to provide a first mono audio signal;
reconstructing a second mono audio signal using a neural network system trained to predict samples of the second mono audio signal given samples of the first mono audio signal and said reconstruction parameters; and
wherein said first mono audio signal and said reconstructed second mono audio signal forms a stereo audio signal pair.

2. A method for reconstructing a stereo audio signal, comprising:
receiving a bitstream including an encoded first mono audio signal and a set of reconstruction parameters;
decoding the encoded first mono audio signal to provide a first mono audio signal;
reconstructing a second mono audio and a third mono audio signal using a neural network system trained to predict samples of the second mono audio signal and samples of the third mono audio signal given samples of the first mono audio signal and said reconstruction parameters,
wherein said reconstructed second mono audio signal and said reconstructed third mono audio signals forms a stereo audio signal pair.

3. The method according to claim 1, wherein said first mono audio signal is a mid audio signal.

4. The method according to claim 3, wherein said reconstructed second mono audio signal is a side mono audio signal.

5. The method according to claim 2, wherein said reconstructed second mono audio signal is a side mono audio signal, and wherein the reconstructed third mono audio signal is an enhanced mid audio signal.

6. The method according to claim 2, wherein the reconstructed second mono audio signal is a left mono audio signal and the reconstructed third mono audio signal is a right mono audio signal.

7. The method according to claim 1, wherein the reconstruction parameters indicate a property of a stereo audio signal associated with the first mono audio signal.

8. The method according to claim 7, wherein the reconstruction parameters are at least one of:
Inter-channel Intensity Difference, IID, parameters,
Inter-channel Cross-Correlation, ICC, parameters, and
Inter-channel Phase Difference, IPD, parameters.

9. The method according to claim 1, wherein the neural network system is trained to operate on flattened audio signal samples, the method further comprising:
envelope flattening the first mono audio signal, to produce a flattened first mono audio signal; and
providing the flattened first mono audio signal to the neural network system and
inverse-flattening at least the reconstructed second mono audio signal.

10. The method according to claim 9, further comprising:
determining the envelope of the first mono audio signal, wherein the envelope flattening and inverse flattening is based on the determined envelope of the first mono audio signal.

11. The method according to claim 1, wherein the neural network system operates on samples in a time-domain, a frequency-domain or a filter-bank domain.

12. The method according to claim 1, further comprising:
determining a correlation level for at least a portion of the first mono audio signal, the correlation level indicating a level of correlation between the first mono audio signal and a stereo audio signal associated with the first mono audio signal;
if said correlation level is below a predetermined threshold level, providing said portion of the first mono audio signal to the neural network model; else, processing said portion of the first mono audio signal with a Linear Time Invariant, LTI, filter to obtain an alternative reconstructed second mono audio signal, said LTI filter comprising of a set of analytically determined filter coefficients.

13. A computer program product comprising instructions which, when the program is executed by a computer, causes the computer to carry out the method according to claim 1.

14. A computer-readable storage medium storing the computer program according to claim 13.

15. (canceled)

16. (canceled)

17. (canceled)

18. The method according to claim 2, wherein the reconstruction parameters indicate a property of a stereo audio signal associated with the first mono audio signal, and wherein the reconstruction parameters are at least one of:
Inter-channel Intensity Difference, IID, parameters,
Inter-channel Cross-Correlation, ICC, parameters, and
Inter-channel Phase Difference, IPD, parameters.

19. The method according to claim 2, wherein the neural network system is trained to operate on flattened audio signal samples, the method further comprising:
envelope flattening the first mono audio signal, to produce a flattened first mono audio signal; and
providing the flattened first mono audio signal to the neural network system; and
inverse-flattening at least the reconstructed second mono audio signal.

20. The method according to claim 19, further comprising:
determining the envelope of the first mono audio signal, wherein the envelope flattening and inverse flattening is based on the determined envelope of the first mono audio signal.

21. The method according to claim 2, wherein the neural network system operates on samples in a time-domain, a frequency-domain or a filter-bank domain.

22. The method according to claim 2, further comprising:
determining a correlation level for at least a portion of the first mono audio signal, the correlation level indicating a level of correlation between the first mono audio signal and a stereo audio signal associated with the first mono audio signal;
if said correlation level is below a predetermined threshold level, providing said portion of the first mono audio signal to the neural network model;
else, processing said portion of the first mono audio signal with a Linear Time Invariant, LTI, filter to obtain an alternative reconstructed second mono audio signal, said LTI filter comprising of a set of analytically determined filter coefficients.

23. A computer program product comprising instructions which, when the program is executed by a computer, causes the computer to carry out the method according to claim 2.
